(19) United States
(12) Patent Application Publication
(10) Pub. No.: US 2025/0121828 A1
(43) Pub. Date: Apr. 17, 2025

(54) VEHICLE CONTROL APPARATUS AND METHOD

(71) Applicants: HYUNDAI MOTOR COMPANY, Seoul (KR); KIA CORPORATION, Seoul (KR)

(72) Inventor: Dong Cheol Jo, Cheonan-si (KR)

(73) Assignees: HYUNDAI MOTOR COMPANY, Seoul (KR); KIA CORPORATION, Seoul (KR)

(21) Appl. No.: 18/631,873

(22) Filed: Apr. 10, 2024

(30) Foreign Application Priority Data
Oct. 16, 2023 (KR) 10-2023-0137803

(51) Int. Cl. B60W 30/182; B60W 50/14; G06V 20/56

(52) U.S. Cl. CPC B60W 30/182; B60W 50/14; G06V 20/56; B60W 2050/143; B60W 2050/146; B60W 2420/403

(57) ABSTRACT

A vehicle control apparatus and method are provided. The vehicle control apparatus may be configured to execute an automatic vehicle wash standby mode based on an identification that the vehicle enters a car wash, through a camera sensor, determine that it is necessary to execute the automatic vehicle wash mode, based on at least one of that a speed of the vehicle is a threshold speed or less, that a gear of the vehicle is set to gear “P” or gear “N”, that it is identified that a distance between a car wash brush and the vehicle is within a threshold distance, through a distance sensor, that moisture is sensed through a rain sensor, or that shaking of the vehicle is sensed through a sensor that senses the shaking of the vehicle, in the automatic vehicle wash standby mode, and execute the automatic vehicle wash mode.

### CROSS-REFERENCE TO RELATED APPLICATION

This application claims the benefit of priority to Korean Patent Application No. 10-2023-0137803, filed in the Korean Intellectual Property Office on Oct. 16, 2023, the entire contents of which are incorporated herein by reference.

### TECHNICAL FIELD

The present disclosure relates to a vehicle control apparatus and method, and more particularly, to a technology for controlling a vehicle wash mode of a vehicle.

### BACKGROUND

As the automobile industries are developing, car washing is also becoming an industry. In particular, a paradigm of the car wash industry has been changed with the advent of automatic car washes that cleans vehicles in a short time period.

Recently, vehicles can perform various operations through electronic controls. For example, operating of wipers, opening and folding of outside mirrors, or opening and closing of windows may be controlled electronically.

Accordingly, when a user uses an automatic car wash, phenomena, such as operation of a wiper, opening of an outside mirror, or opening of a window may occur during automatic car washing due to the inexperience of the user.

In recent vehicles, the user may set a vehicle wash mode that activates functions, such as switching-off of the wipers, folding of the outside mirrors, and closing of the windows.

However, there is the inconvenience of having to select this car wash mode by the user. Accordingly, drivers who are inexperienced in using a vehicle are not familiar with setting of the car wash mode, and the same problem may easily occur again.

Accordingly, when a driver uses an automatic vehicle wash, a technology that enables the vehicle wash mode to be easily executed is required.

### SUMMARY

The present disclosure has been made to solve the above-mentioned problems occurring in the prior art while advantages achieved by the prior art are maintained.

An aspect of the present disclosure provides a vehicle control apparatus and method that allows the user to conveniently execute an automatic vehicle wash mode by automatically recognizing a car wash and notifying a user whether the automatic vehicle wash mode is executed.

An aspect of the present disclosure also provides a vehicle control apparatus and method that improves an accuracy of determination of whether a vehicle enters a car wash by using a transmission, a distance sensor, a rain sensor, and a shaking sensing sensor of a vehicle.

An aspect of the present disclosure also provides a vehicle control apparatus and method that may prevent damage to a user or a vehicle by performing functions that are preferentially required before car washing begins in an automatic vehicle wash standby mode even when a user does not execute an automatic vehicle wash mode after the vehicle enters the car wash.

An aspect of the present disclosure also provides a vehicle control apparatus and method that may prevent operations according to an automatic vehicle wash mode from being changed while a vehicle is washed by continuously sensing whether an operation state according to execution of the automatic vehicle wash mode is maintained.

The technical problems to be solved by the present disclosure are not limited to the aforementioned problems, and any other technical problems not mentioned herein should be clearly understood from the following description by those having ordinary skill in the art to which the present disclosure pertains.

According to an aspect of the present disclosure, a vehicle control apparatus includes a memory that stores program instructions, and a processor that executes the program instructions. The processor may be configured to: execute an automatic vehicle wash standby mode of determining whether it is necessary to execute an automatic vehicle wash mode of operating a function required for a vehicle before the vehicle is washed, based on an identification that the vehicle enters a car wash, through a camera sensor; determine that it is necessary to execute the automatic vehicle wash mode, based on at least one of that a speed of the vehicle is a threshold speed or less, that a gear of the vehicle is set to gear “P” or gear “N”, that it is identified that a distance between a car wash brush and the vehicle is within a threshold distance, through a distance sensor, that moisture is sensed through a rain sensor, or that shaking of the vehicle is sensed through a sensor that senses the shaking of the vehicle, or any combination thereof, in the automatic vehicle wash standby mode; and execute the automatic vehicle wash mode.

In an embodiment, the processor may execute at least one of folding of an outside mirror of the vehicle, closing of a door glass, closing of a sunroof, switching-off of the rain sensor, locking of an automatic flush door handle, locking of a power tailgate, locking of a power sliding door, locking of an EV charging door, or locking of a frunk, or any combination thereof, based on that the automatic vehicle wash mode is executed.

In an embodiment, the processor may provide a notification for identifying whether the automatic vehicle wash mode is executed, through at least one of a display or an audio component, or any combination thereof, based on that it is determined that it is necessary to execute the automatic vehicle wash mode, in the automatic vehicle wash standby mode.

In an embodiment, the processor may not execute the automatic vehicle wash mode, based on an identification that the automatic vehicle wash mode is not executed by a user, and to execute the automatic vehicle wash mode, based on an identification that the automatic vehicle wash mode is executed by the user.

In an embodiment, the processor may release the automatic vehicle wash mode based on an identification that a start of the vehicle is switched on again after the start of the vehicle is switched off, in the automatic vehicle wash mode, or release the automatic vehicle wash mode based on an identification that the gear of the vehicle is set to gear “D” or gear “R”, in the automatic vehicle wash mode.

In an embodiment, the processor may return, based on that the automatic vehicle wash mode is released, at least one of an outside mirror, a door glass, a sunroof, the rain sensor, an automatic flush door handle, a power tailgate, a power sliding door, an EV charging door, or a frunk of the vehicle, or any combination thereof to a state before the automatic vehicle wash mode is executed.

In an embodiment, the processor may execute the automatic vehicle wash mode again, based on an identification that a state corresponding to at least one of folding of the outside mirror of the vehicle, closing of the door glass, closing of the sunroof, switching-off of the rain sensor, locking of the automatic flush door handle, locking of the power tailgate, locking of the power sliding door, locking of the EV charging door, or locking of the frunk, or any combination thereof is not maintained.

In an embodiment, the processor may execute, based on that the automatic vehicle wash standby mode is executed, a first function including at least one of folding of an outside mirror of the vehicle, closing of a door glass of row 1, closing of a sunroof, or switching-off of a wiper, or any combination thereof, and based on that the automatic vehicle wash mode is executed, execute a second function including at least one of locking of an automatic flush door handle, closing of a door glass of row 2 or more, locking of a power tailgate, locking of a power sliding door, locking of an EV charging door, or a locking of a frunk, or any combination thereof.

In an embodiment, the processor may determine, based on an identification that a start of the vehicle is switched off, in the automatic vehicle wash standby mode, that it is necessary to execute the automatic vehicle wash mode, based on at least one of that the speed of the vehicle is the threshold speed or less, that the gear of the vehicle is set to gear “P” or gear “N”, that the distance between the car wash brush and the vehicle is identified to be within the threshold distance through the distance sensor, that moisture is sensed through the rain sensor, or that shaking of the vehicle is sensed through the sensor that senses the shaking of the vehicle, or any combination thereof, by operating a timer for a preset time period.

According to another aspect of the present disclosure, a vehicle control apparatus includes a memory that stores program instructions, and a processor that executes the program instructions. The processor executes an automatic vehicle wash standby mode of determining whether it is necessary to execute an automatic vehicle wash mode of operating a function required for a vehicle before the vehicle is started to be washed, based on an identification that the vehicle enters a car wash, through a camera sensor, and executes the automatic vehicle wash mode, based on that opening of a door of the vehicle is identified and a first operation of a key of the vehicle is identified, in the automatic vehicle wash standby mode.

In an embodiment, the processor may release the automatic vehicle wash mode, based on that a second operation of the key of the vehicle is identified, in the automatic vehicle wash mode.

According to another aspect of the present disclosure, a vehicle control method includes: executing, by a processor, an automatic vehicle wash standby mode of determining whether it is necessary to execute an automatic vehicle wash mode of operating a function required for a vehicle before the vehicle is washed, based on an identification that the vehicle enters a car wash, through a camera sensor; determining, by the processor, that it is necessary to execute the automatic vehicle wash mode, based on that a speed of the vehicle is a threshold speed or less, that a gear of the vehicle is set to gear “R” or gear “N”, that it is identified that a distance between a car wash brush and the vehicle is within a threshold distance, through a distance sensor, that moisture is sensed through a rain sensor, or that shaking of the vehicle is sensed through a sensor that senses the shaking of the vehicle, or at least one of any combinations thereof, in the automatic vehicle wash standby mode; and executing, by the processor, the automatic vehicle wash mode.

In an embodiment, the executing, by the processor, of the automatic vehicle wash mode may include executing, by the processor, at least one of folding of an outside mirror of the vehicle, closing of a door glass, closing of a sunroof, switching-off of the rain sensor, locking of an automatic flush door handle, locking of a power tailgate, locking of a power sliding door, locking of an EV charging door, or locking of a frunk, or any combination thereof, based on that the automatic vehicle wash mode is executed.

In an embodiment, the vehicle control method may further include providing, by the processor, a notification for identifying whether the automatic vehicle wash mode is executed, through at least one of a display or an audio component, or any combination thereof, based on a determination that it is necessary to execute the automatic vehicle wash mode, in the automatic vehicle wash standby mode.

In an embodiment, the executing, by the processor, of the automatic vehicle wash mode may include not executing, by the processor, the automatic vehicle wash mode, when it is identified that the automatic vehicle wash mode is not executed by a user, and executing the automatic vehicle wash mode, when it is identified that the automatic vehicle wash mode is executed by the user.

In an embodiment, the vehicle control method may further include releasing, by the processor, the automatic vehicle wash mode based on an identification that a start of the vehicle is switched on again after the start of the vehicle is switched off, in the automatic vehicle wash mode, or releasing the automatic vehicle wash mode based on an identification that the gear of the vehicle is set to gear “D” or gear “R”, in the automatic vehicle wash mode.

In an embodiment, the releasing, by the processor, of the automatic vehicle wash mode based on the identification that the start of the vehicle is switched on again after the start of the vehicle is switched off, in the automatic vehicle wash mode, or the releasing of the automatic vehicle wash mode based on the identification that the gear of the vehicle is set to gear “D” or gear “R”, in the automatic vehicle wash mode may include returning, by the processor, at least one of an outside mirror, a door glass, a sunroof, the rain sensor, an automatic flush door handle, a power tailgate, a power sliding door, an EV charging door, or a frunk of the vehicle, or any combination thereof to a state before the automatic vehicle wash mode is executed.

In an embodiment, the executing, by the processor, of the automatic vehicle wash mode may include executing the automatic vehicle wash mode again, based on an identification that a state corresponding to at least one of folding of the outside mirror of the vehicle, closing of the door glass, closing of the sunroof, switching-off of the rain sensor, locking of the automatic flush door handle, locking of the power tailgate, locking of the power sliding door, locking of the EV charging door, or locking of the frunk, or any combination thereof is not maintained.

In an embodiment, the executing, by the processor, of the automatic vehicle wash standby mode of determining whether it is necessary to execute the automatic vehicle wash mode of operating the function required for the vehicle before the vehicle is washed, based on the identification that the vehicle enters the car wash, through the camera sensor may include executing, by the processor, a first function including at least one of folding of an outside mirror of the vehicle, closing of a door glass of row 1, closing of a sunroof, or switching-off of a wiper, or any combination thereof, based on the automatic vehicle wash standby mode being executed, and the executing, by the processor, of the automatic vehicle wash mode may include executing, by the processor, a second function including at least one of locking of an automatic flush door handle, closing of a door glass of row 2 or more, locking of a power tailgate, locking of a power sliding door, locking of an EV charging door, or a locking of a frunk, or any combination thereof, based on the automatic vehicle wash mode being executed.

In an embodiment, the determining, by the processor, that it is necessary to execute the automatic vehicle wash mode, based on that the speed of the vehicle is the threshold speed or less, that the gear of the vehicle is set to gear “R” or gear “N”, that it is identified that the distance between the car wash brush and the vehicle is within the threshold distance, through the distance sensor, that moisture is sensed through the rain sensor, or that shaking of the vehicle is sensed through the sensor that senses the shaking of the vehicle, or at least one of any combinations thereof, in the automatic vehicle wash standby mode may include determining, by a controller, that it is necessary to execute the automatic vehicle wash mode, based on at least one of that the speed of the vehicle is the threshold speed or less, that the gear of the vehicle is set to gear “P” or gear “N”, that the distance between the car wash brush and the vehicle is identified to be within the threshold distance through the distance sensor, that moisture is sensed through the rain sensor, or that shaking of the vehicle is sensed through the sensor that senses the shaking of the vehicle, or any combination thereof, by operating a timer for a preset time period, based on an identification that a start of the vehicle is switched off, in the automatic vehicle wash standby mode.

### BRIEF DESCRIPTION OF THE DRAWINGS

The above and other objects, features and advantages of the present disclosure should be more apparent from the following detailed description taken in conjunction with the accompanying drawings:

FIG. 1 is a block diagram showing a vehicle control apparatus according to an embodiment of the present disclosure;

FIG. 2 is a block diagram illustrating a vehicle control system including a vehicle control apparatus according to an embodiment of the present disclosure;

FIG. 3 is a flowchart illustrating a vehicle control method according to an embodiment of the present disclosure;

FIGS. 4A and 4B are flowcharts illustrating failsafe logic for a process of determining whether it is necessary to execute an automatic vehicle wash mode and a method for releasing the automatic vehicle wash mode in a vehicle control apparatus or method according to an embodiment of the present disclosure;

FIG. 5 is a flowchart illustrating a process for maintaining an operating state depending on an automatic vehicle wash mode in a vehicle control apparatus or method according to an embodiment of the present disclosure;

FIG. 6 is a flowchart illustrating a method for executing an automatic vehicle wash mode from an outside of a vehicle in a vehicle control apparatus or method according to an embodiment of the present disclosure;

FIG. 7 is a flowchart illustrating a process in which an operation according to execution of an automatic vehicle wash standby mode and an operation according to execution of an automatic vehicle wash mode are operated separately in a vehicle control apparatus or method according to an embodiment of the present disclosure; and

FIG. 8 illustrates a computing system related to a vehicle control apparatus or method according to an embodiment of the present disclosure.

### DETAILED DESCRIPTION

Hereinafter, some embodiments of the present disclosure are described in detail with reference to the drawings. In adding the reference numerals to the components of each drawing, it should be noted that the identical or equivalent component is designated by the identical numeral even when they are displayed on other drawings. Further, in describing the embodiments of the present disclosure, a detailed description of well-known features or functions are omitted in order not to unnecessarily obscure the gist of the present disclosure.

In describing the components of the embodiments according to the present disclosure, terms such as first, second, “A”, “B”, (a), (b), and the like may be used. These terms are merely intended to distinguish one component from another component, and the terms do not limit the nature, sequence or order of the constituent components. Furthermore, the expression of “at least one of “A”, “B”, or “C”, or any combination thereof may include all of “A” or “B” or “C”, or AB or BC or AC or ABC” that are combinations thereof.

Unless otherwise defined, all terms used herein, including technical or scientific terms, have the same meanings as those generally understood by those having ordinary skill in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

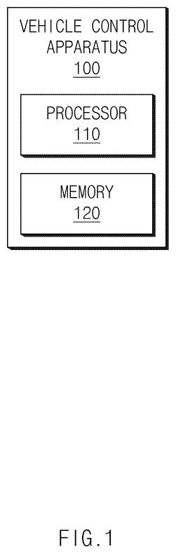

Hereinafter, embodiments of the present disclosure are described in detail with reference to FIGS. 1-8.

FIG. 1 is a block diagram showing a vehicle control apparatus according to an embodiment of the present disclosure.

According to an embodiment, a vehicle control apparatus 100 may include a processor 110 and a memory 120. A configuration of the vehicle control apparatus 100 illustrated in FIG. 1 is illustrative, and embodiments of the present disclosure are not limited thereto. For example, the vehicle control apparatus 100 may further include components that are not illustrated in FIG. 1.

According to an embodiment, the memory 120 may store commands or data. For example, the memory 120 may store one instruction or two or more instructions that, when being executed by the processor 110, cause the vehicle control apparatus 100 to perform various operations.

According to an embodiment, the memory 120 may include a non-volatile memory (a read only memory (ROM)) and a volatile memory (a random access memory (RAM)).

According to an embodiment, the memory 120 may be implemented as a single chipset with the processor 110, and may store various information related to the vehicle control apparatus 100. For example, the memory 120 may store information on an operation history of the processor 110. For example, operations or functions depending on automatic vehicle wash modes may be stored in the memory 120.

According to an embodiment, the processor 110 may execute an automatic vehicle wash standby mode of determining whether it is necessary to execute an automatic vehicle wash mode of operating a function required for the vehicle before the vehicle is washed, based on an identification that the vehicle enters a car wash, through a camera sensor.

According to an embodiment, the camera sensor may include cameras, such as a built-in camera, a front camera, a rear camera, a mono camera, and a stereo camera, which may capture or sense surroundings of the vehicle.

According to an embodiment, the processor 110 may identify whether a vehicle enters a car wash by using car wash information. For example, the car wash information may include data related to shapes of the car wash, an automatic car wash machine, and the like. In detail, the car wash information may include data on major domestic and foreign car washes or automatic car wash machines. In addition, the processor 110 may receive the car wash information, which is stored in an external server, or receive the car wash information, which is stored in the memory 120, to identify whether the vehicle enters the car wash.

For example, the processor 110 may compare an image of an outside of the vehicle, which is recognized through the camera sensor, with the car wash information, which is stored in the memory 120, to identify whether the vehicle enters the car wash.

According to an embodiment, the processor 110 may learn the car wash information using an image of the car wash, which is recognized through the camera sensor. For example, when the car wash recognized through the camera sensor is a car wash that is not included in the car wash information, the car wash recognized through the camera sensor may be updated in the car wash information, based on the vehicle wash mode being operated by a user.

According to an embodiment, the automatic vehicle wash standby mode may include a mode of determining whether it is necessary to execute the automatic vehicle wash mode. For example, when it is identified that the vehicle enters the car wash, a vehicle wash may be performed. Thus, it may be determined that it is necessary to execute the automatic vehicle wash mode.

According to an embodiment, the processor 110 may determine that it is necessary to execute the automatic vehicle wash mode, based on at least one of that a speed of the vehicle is a threshold speed or less, that a gear of the vehicle is set to gear “P” or gear “N”, that it is identified that a distance between a car wash brush and the vehicle is within a threshold distance (through a distance sensor), that moisture is sensed through a rain sensor, or that shaking of the vehicle is sensed through a sensor that senses the shaking of the vehicle, or any combination thereof.

According to an embodiment, the threshold speed may include a speed at which the vehicle enters the car wash or the car wash machine to be washed. For example, the threshold speed may include a low speed, at which the vehicle enters the automatic car wash machine. As a detailed example, the threshold speed may be set to 10 km/h.

According to an embodiment, the processor 110 may determine that it is necessary to execute the automatic vehicle wash mode when the gear of the vehicle is set to gear “P” or gear “N”. As another example, even when the gear of the vehicle is set not only to gear “P” or gear “N” but also to a gear that may stop the vehicle, it may be determined that it is necessary to execute the automatic vehicle wash mode. In detail, it may be determined that it is necessary to execute the automatic vehicle wash mode even when an auto hold function of the vehicle is operated.

According to an embodiment, the processor 110 may determine that it is necessary to execute the automatic vehicle wash mode when it is identified that a distance between the car wash brush and the vehicle is within the threshold distance, through a distance sensor.

For example, the distance sensor may include a sensor that senses a distance between the vehicle and a surrounding object. As another example, the distance sensor may include a sensor that senses a surrounding object that approaches the vehicle. As a detailed example, the distance sensor may include a parking assistance system (PAS) sensor.

For example, the car wash brush may include a brush that is used to wash the vehicle. In detail, it may include a car wash brush of the automatic car wash machine.

For example, the threshold distance may include a distance at which the car wash brush approaches the vehicle to wash the vehicle. As a detailed example, the threshold distance may be set to a distance including 0. Then, when the distance between the vehicle and the car wash brush, which is sensed by the distance sensor, is 0, it may be identified that the car wash brush contacts the vehicle, and it may be determined that it is necessary to execute the automatic vehicle wash mode.

According to an embodiment, when the gear of the vehicle is set to gear “P” or gear “N” and it is identified that the distance between the car wash brush and the vehicle is within the threshold distance, through the distance sensor, it is determined that it is necessary to execute the automatic vehicle wash mode. For example, when it is identified that the distance between the car wash brush and the vehicle is within the threshold distance, through the distance sensor, while the gear of the vehicle is set to gear “D” or gear “R”, it may be determined that the vehicle is in an accident. However, when it is identified that the distance between the car wash brush and the vehicle is within the threshold distance, through the distance sensor, while the gear of the vehicle is set to gear “P” or gear “N”, it may be determined that the car wash brush contacts the vehicle to wash the vehicle.

According to an embodiment, the processor 110 may determine that it is necessary to execute the automatic vehicle wash mode when moisture is sensed through a rain sensor. The rain sensor may sense water droplets on a windshield or an outer plate of the vehicle. As a detailed example, the rain sensor may include a sensor that emits infrared rays and senses a wavelength between the infrared rays that hit a glass window and return to the sensor. Then, when water droplets accumulate on the window, the rain sensor senses diffuse reflection and may sense moisture on the window.

According to an embodiment, the processor 110 may determine that it is necessary to execute the automatic vehicle wash mode when shaking of the vehicle is sensed through a sensor that senses shaking of the vehicle.

For example, the sensor that senses shaking of a vehicle may include a radar sensor that senses indoor movement or shaking. As a detailed example, it may include a rear occupant alert (ROA) sensor. In detail, when shaking of the vehicle is sensed as the car wash brush washes the vehicle, the processor 110 may determine that it is necessary to execute the automatic vehicle wash mode.

According to an embodiment, when the processor 110 determines that it is necessary to execute the automatic vehicle wash mode in the automatic vehicle wash standby mode, it may execute the automatic vehicle wash mode.

According to an embodiment, the automatic vehicle wash mode may include a mode that operates a function that is required for the vehicle before the vehicle is washed. For example, it may include a mode that operates the function of the vehicle to prevent damage to the vehicle, such as damage to the vehicle or scratches, or damage to the user due to wash water that flows into an interior of the vehicle, even when the vehicle is washed through the automatic car wash machine.

According to an embodiment, when the automatic vehicle wash mode is executed, the processor 110 may execute a function of the vehicle for preventing damage, such as damage to the vehicle or damage to the user due to wash water that flows into the interior while the vehicle is washed.

For example, the processor 110 may execute at least one of folding of an outside mirror of the vehicle, closing of a door glass, closing of a sunroof, switching-off of the rain sensor, locking of an automatic flush door handle, locking of a power tailgate, locking of a power sliding door, locking of an EV charging door, or locking of a frunk, or any combination thereof, when the automatic vehicle wash mode is executed.

For example, when the automatic vehicle wash mode is executed, the processor 110 may fold the outside mirror of the vehicle to perform a control such that the outside mirror is not automatically unfolded while the vehicle is washed.

For example, when the automatic vehicle wash mode is executed, the processor 110 may switch off the rain sensor to perform a control such that the wipers are not automatically operated even when moisture is sensed while the vehicle is washed.

For example, when the automatic vehicle wash mode is executed, the processor 110 may perform a control such that the automatic flush door handle is not automatically opened while the vehicle is washed, by locking the automatic flush door handle. The automatic flush door handle may include a vehicle door handle that is normally hidden in the vehicle door but pops out when the user uses it.

For example, when the automatic vehicle wash mode is executed, the processor 110 may perform a control such that the trunk door is not automatically opened by locking the power tailgate while the vehicle is washed. The power tailgate may include a trunk, to which an electric motor is connected, and a trunk door of which may be automatically opened or closed by using a button or a motion.

For example, when the automatic vehicle wash mode is executed, the processor 110 may perform a control such that the sliding door is not automatically opened while the vehicle is washed, due to the locking of the power sliding door. The power sliding door may include a door, to which an electric motor is connected, and which may be automatically opened or closed by using a button or a motion.

For example, when the automatic vehicle wash mode is executed, the processor 110 may lock the EV charging door to perform a control such that the EV charging door is not automatically opened while the vehicle is washed.

For example, when the automatic vehicle wash mode is executed, the processor 110 may lock the frunk such that the frunk is not automatically opened while the door is washed, due to the locking of the frunk. The frunk may include a cargo loading space in an engine room on a front side of the vehicle.

According to an embodiment, all of the above functions executed according to the automatic vehicle wash mode may be executed simultaneously or sequentially. As another example, only the functions that require operations may be selected and executed. In detail, when the automatic vehicle wash mode is executed while the door glass is opened and the sunroof is already closed, only a function of closing the door glass may be executed.

According to an embodiment, the processor 110 may provide a notification for identifying whether the automatic vehicle wash mode is executed, through at least one of a display or an audio, or any combination thereof, based on it being determined that it is necessary to execute the automatic vehicle wash mode, in the automatic vehicle wash standby mode.

For example, when it is determined that it is necessary to execute the automatic vehicle wash mode in the automatic vehicle wash standby mode, the processor 110 may provide the user with a notification that the automatic vehicle wash mode is executed, through a display or audio. In this example, the display may include a touch type display.

As a detailed example, a notification for selecting whether the automatic vehicle wash mode is not to be executed may be provided. In other words, when the user selects not to execute the automatic vehicle wash mode, the processor 110 may not execute the automatic vehicle wash mode. To the contrary, when the user selects to execute the automatic vehicle wash mode, or makes no selection, the processor 110 may automatically execute the automatic vehicle wash mode.

For example, the processor 110 may ask the user whether to execute the automatic vehicle wash mode through a popup window on the display. In this case, the user may select whether to execute vehicle wash mode by touching the popup window.

As another example, the processor 110 may ask the user whether to execute the automatic vehicle wash mode via audio. In this case, the user may select whether to execute the automatic vehicle wash mode through voice.

According to an embodiment, when the user does not agree to execution of the automatic vehicle wash mode, the processor 110 may not execute the automatic vehicle wash mode.

According to an embodiment, when the user agrees to execute the automatic vehicle wash mode, the processor 110 may execute the automatic vehicle wash mode. In this case, the processor 110 may execute the automatic vehicle wash mode as the user selects execution of the automatic vehicle wash mode, or may automatically execute the automatic vehicle wash mode when the user makes no selection. In other words, when the processor 110 determines that it is necessary to execute the automatic vehicle wash mode and when there is no selection not to agree to execution of the automatic vehicle wash mode for a specific time period, the processor 110 may automatically execute the automatic vehicle wash mode.

According to an embodiment, the processor 110 may release the automatic vehicle wash mode based on it being identified that the start of the vehicle is switched on again after the start of the vehicle is switched off in the automatic vehicle wash mode.

For example, even after the automatic vehicle wash mode is executed, a situation in which the user needs to release the automatic vehicle wash mode may occur. In this case, the user may release the automatic vehicle wash mode by switching the start of the vehicle off and then on again.

According to an embodiment, the processor 110 may release the automatic vehicle wash mode based on it being identified that the gear of the vehicle is set to gear “D” or gear “R” in the automatic vehicle wash mode.

For example, even after the automatic vehicle wash mode is executed, the processor 110 may determine that the user is to release the automatic vehicle wash mode when the user sets the gear of the vehicle to gear “D” or gear “R”. In this case, the processor 110 may release the executed vehicle wash mode.

According to an embodiment, when the automatic vehicle wash mode is released, the processor 110 may return at least one of the outside mirror, the door glass, the sunroof, the rain sensor, the automatic flush door handle, the power tailgate, the power sliding door, the EV charging door, or the frunk of the vehicle, or any combination thereof to a state before the automatic vehicle wash mode was executed.

For example, when the automatic vehicle wash mode is executed while the outside mirror of the vehicle is unfolded, the door glass is opened, and the sunroof is closed, the processor 110 may be operated to fold the outside mirror and close the door glass, and maintain the sunroof in a closed state. Thereafter, when the automatic vehicle wash mode is released, the processor 110 may be operated to unfold the outside mirror of the vehicle again, open the door glass, and maintain the sunroof in the closed state.

For example, the processor 110 may store the states of the outside mirror, the door glass, the sunroof, the rain sensor, the automatic flush door handle, the power tailgate, the power sliding door, the EV charging door, and the frunk in the memory 120, and return the states to the states before the automatic vehicle wash mode was executed when the automatic vehicle wash mode is released.

According to an embodiment, the processor 110 may sense an operating state according to execution of the automatic vehicle wash mode. For example, the processor 110 may monitor whether a state corresponding to at least one of folding of the outside mirror, closing of the door glass, closing of the sunroof, switching-off of the rain sensor, locking of the automatic flush door handle, locking of the power tailgate, locking of the power sliding door, locking of the EV charging door, or locking of the frunk, or any combination thereof is maintained.

According to an embodiment, the processor 110 may execute the automatic vehicle wash mode again when it is identified that the operating state according to execution of the automatic vehicle wash mode is not maintained. For example, when it is sensed that the door glass is opened due to a malfunction or a mistake of the user even though the automatic vehicle wash mode is executed and the door glass is closed, the processor 110 may execute the automatic vehicle wash mode again to close the door glass.

In detail, when the outside mirror of the vehicle is folded, the door glass is closed, and the sunroof is closed according to the execution of the automatic vehicle wash mode, the processor 110 may sense whether the folding of the outside mirror of the vehicle, the closing of the door glass, and the closing of the sunroof are maintained while the vehicle is washed.

For example, when it is sensed that the outside mirror of the vehicle is unfolded, the door glass is opened, or the sunroof is opened before the automatic vehicle wash mode is released, the processor 110 may execute the automatic vehicle wash mode again to fold the outside mirror of the vehicle, close the door glass, or close the sunroof.

According to an embodiment, the processor 110 may be operated while distinguishing an operation according to the automatic vehicle wash standby mode and an operation according to the automatic vehicle wash mode.

According to an embodiment, when the automatic vehicle wash standby mode is executed, the processor 110 may first execute a function that needs to be operated first to prevent damage to the vehicle or the user even before the automatic vehicle wash mode is executed.

For example, when the automatic vehicle wash standby mode is executed, the processor 110 may execute a first function including at least one of folding of the outside mirror of the vehicle, closing of the door glass of row 1, closing of the sunroof, or switching-off of the wiper, or any combination thereof. The operations included in the first function may vary depending on a system or a setting of the user. Furthermore, it may be operated differently depending on a direction in which the vehicle is washed.

According to an embodiment, when the automatic vehicle wash mode is executed, the processor 110 may execute the remaining operations that are not included in the first function according to, among the functions required for the vehicle before the vehicle starts to be washed, the automatic vehicle wash standby mode.

For example, when the automatic vehicle wash mode is executed, the processor 110 may execute a second function including at least one of locking of the automatic flush door handle, closing of the door glass of row 2 or more, locking of the power tailgate, locking of the power sliding door, locking of the EV charging door, or locking of the frunk, or any combination thereof. The operations included in the second function may vary depending on a system or a setting of the user. Furthermore, operations that are not included in the first function may be included in consideration of the first function according to the automatic vehicle wash standby mode.

According to an embodiment, the processor 110 may determine whether it is necessary to execute the automatic vehicle wash mode even though the start of the vehicle is switched off in the automatic vehicle wash standby mode. For example, even though the start of the vehicle is switched off, energy that is required to determine whether it is necessary to execute the automatic vehicle wash mode may be supplied. In detail, electric power may be supplied to the processor 110, a sensor, and the like.

According to an embodiment, the processor 110 may determine whether it is necessary to execute the automatic vehicle wash mode, by operating a timer for a preset time period even though the start of the vehicle ignition is switched off in the automatic vehicle wash standby mode.

For example, the preset time period may include a time period for the processor 110 to determine whether it is necessary to execute the automatic vehicle wash mode, and may be set in consideration of a car wash pattern. As a detailed example, the preset time may be set to 10 seconds.

For example, the processor 110 may determine that it is necessary to execute the automatic vehicle wash mode, based on at least one of that a speed of the vehicle is a threshold speed or less, that a gear of the vehicle is set to gear “P” or gear “N”, that it is identified that a distance between a car wash brush and the vehicle is within a threshold distance (through a distance sensor), that moisture is sensed through a rain sensor, or that shaking of the vehicle is sensed through a sensor configured to sense the shaking of the vehicle, or any combination thereof, in the automatic vehicle wash standby mode.

Accordingly, when it is determined that it is necessary to execute the automatic vehicle wash mode even after the start of the vehicle is switched off, the processor 110 may execute the automatic vehicle wash mode.

According to an embodiment, in the automatic vehicle wash standby mode, the user may execute the automatic vehicle wash mode outside the vehicle by using the key of the vehicle. For example, the processor 110 may execute the automatic vehicle wash mode when the user presses a button on the key of the vehicle as a first operation. In this example, the first operation may include an operation of pressing a specific button on the key of the vehicle with a specific rule. As a specific example, the automatic vehicle wash mode may be set to be executed when the user presses a lock button or an unlock button that is provided on the key of the vehicle for 5 seconds outside the vehicle.

For example, in the automatic vehicle wash standby mode, the processor 110 may determine that the user has gotten out of the vehicle when the door of the vehicle is opened. Furthermore, the processor 110 may execute the automatic vehicle wash mode when an operation of the key of the vehicle of executing the automatic vehicle wash mode is identified. As another example, the processor 110 may determine that the user has gotten out of the vehicle through various methods other than opening the door of the vehicle.

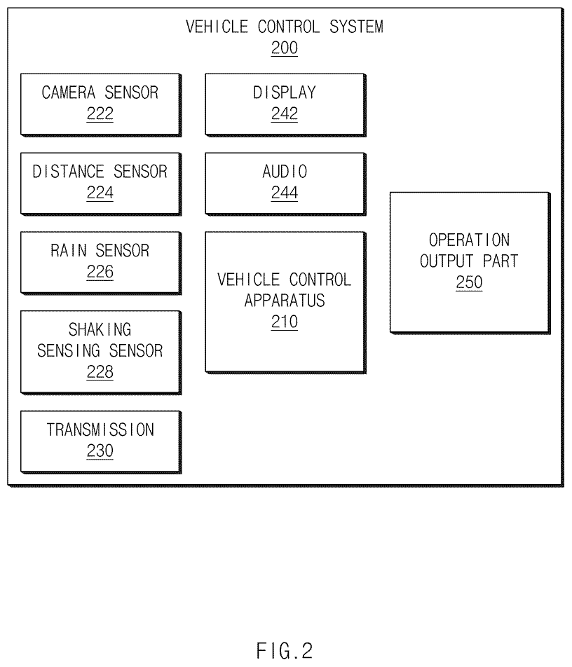

FIG. 2 is a block diagram illustrating a vehicle control system including a vehicle control apparatus according to an embodiment of the present disclosure.

According to an embodiment, a vehicle control system 200 includes a vehicle control apparatus 210, a camera sensor 222, a distance sensor 224, a rain sensor 226, a shaking sensing sensor 228, a transmission 230, a display 242, an audio component 244, and an operation output part 250. The configuration of the vehicle control system 200 illustrated in FIG. 2 is illustrative, and the embodiments of the present disclosure are not limited thereto. For example, the vehicle control system 200 may further include components that are not illustrated in FIG. 2.

According to an embodiment, the vehicle control apparatus 210, the camera sensor 222, the distance sensor 224, the rain sensor 226, and the shaking sensing sensor 228 illustrated in FIG. 2 may perform the same or similar functions to the vehicle control apparatus 100, the camera sensor, the distance sensor, the rain sensor, and the shaking sensing sensor. For example, the vehicle control apparatus 210 may include a processor and a memory.

According to an embodiment, the transmission 230 may refer to a device that converts power generated by the engine into a necessary rotational force depending on the speed and transmits it. For example, the user may change the gear of the vehicle by using the transmission 230. In detail, the gear may be set to gear “D” to move the vehicle forward, be set to gear “R” to move the vehicle backward, be set to gear “N” to stop the vehicle, or be set to gear “P” to park the vehicle.

According to an embodiment, the vehicle control apparatus 210 may sense the gear of the vehicle that is changed through the transmission 230, and it may determine whether the automatic vehicle wash standby mode or the automatic vehicle wash mode is executed based on the sensed gear of the vehicle.

According to an embodiment, the display 242 or the audio 244 may provide vehicle-related notifications to the user. For example, the vehicle control apparatus 210 may provide a notification for identifying whether the automatic vehicle wash mode is executed, through the display 242 or the audio 244, based on it being necessary to execute the automatic vehicle wash mode, in the automatic vehicle wash standby mode. As a specific example, a popup window regarding a notification that asks the user whether to execute the automatic vehicle wash mode may be displayed on the display 242, or the user may be asked whether to execute the automatic vehicle wash mode, through the audio 244 voice.

According to an embodiment, the operation output part 250 may perform an output related to an operation according to the automatic vehicle wash standby mode or an operation according to the automatic vehicle wash mode. For example, the operation output part 250 may manage an output for an operation of the outside mirror, the door glass, the sunroof, the rain sensor, the automatic flush door handle, the power tailgate, the power sliding door, the EV charging door, the frunk, and the like.

In a detailed example, when folding of the outside mirror of the vehicle, closing of the door glass, closing of the sunroof, switching-off of the rain sensor, locking of the automatic flush door handle, locking of the power tailgate, locking of the power sliding door, locking of the EV charging door, or locking of the frunk is executed as the vehicle control apparatus 210 executes the automatic vehicle wash mode, an execution command may be delivered through the operation output part 250.

However, this is a simple example, and the vehicle control apparatus 210 may directly perform an output related to the corresponding operation without going through the operation output part 250.

According to an embodiment according to FIG. 2, the vehicle control apparatus 210 may determine whether it is necessary to execute the automatic vehicle wash mode, through the camera sensor 222, the distance sensor 224, the rain sensor 226, the shaking sensing sensor 228, or the transmission 230. Furthermore, the vehicle control apparatus 210 may provide a notification related to whether the automatic vehicle wash mode is executed to the user, through the display 242 or the audio 244. When the automatic vehicle wash mode is executed, the vehicle control apparatus 210 may perform operations, such as folding of the outside mirror of the vehicle, closing of the door glass, and closing of the sunroof, through the operation output part 250 to prevent the user or the vehicle from being damaged by the car wash brush or the wash water.

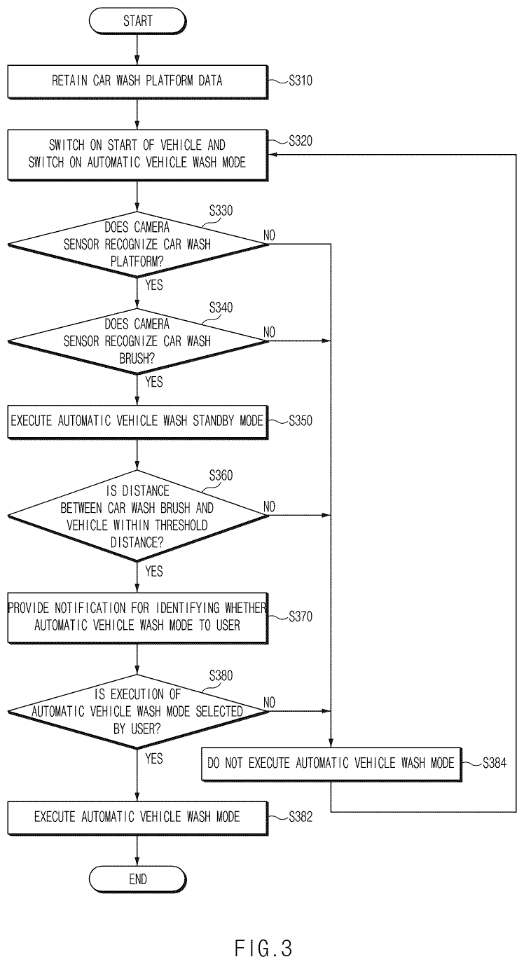

Hereinafter, a vehicle control method according to an embodiment of the present disclosure is described in detail with reference to FIGS. 3-7.

Hereinafter, it may be assumed that the vehicle control apparatus 100 of FIG. 1 performs the processes of FIGS. 3-7. Furthermore, in the description of FIGS. 3-7, operations described as being performed by the apparatus may be understood as being controlled by the processor 110 of the vehicle control apparatus 100.

FIG. 3 is a flowchart illustrating a vehicle control method according to an embodiment of the present disclosure. The vehicle control method may be performed by the vehicle control apparatus.

According to an embodiment, the vehicle control apparatus may retain car wash platform data that are necessary to identify a vehicle that enters a car wash (S310). Alternatively, the vehicle control apparatus may receive car wash platform data from an external server.

For example, the car wash platform data may include data related to a car wash. In detail, it may include data, such as video or images related to a shape of the car wash or the automatic car wash machine.

As another example, the vehicle control apparatus may learn car wash platform data that is recognized through camera sensors, and the like, as big data. For example, when the automatic vehicle wash mode is executed by the user after the vehicle enters a car wash that is not included in the car wash platform data, the corresponding car wash information may be trained on the platform data.

According to an embodiment, the processor may perform a process for executing the automatic vehicle wash standby mode or the automatic vehicle wash mode when the start of the vehicle is switched on and setting of the automatic vehicle wash mode is activated (S320). For example, the user may activate the automatic vehicle wash mode in a user setting mode (USM) of the vehicle, and when the automatic vehicle wash mode in the USM is activated, the processor may perform a process for executing the automatic vehicle wash standby mode or automatic vehicle wash mode. Accordingly, when the user does not want the vehicle to automatically execute the automatic vehicle wash mode, the user may not activate vehicle wash mode in the USM.

According to an embodiment, the processor may recognize a car wash platform through the camera sensor (S330). For example, the processor may identify whether a form of the car wash platform, which is recognized through the camera sensor, matches the held (i.e., stored) car wash platform data. Furthermore, when the recognized form of the car wash platform matches the held car wash platform data, the processor may determine that the vehicle enters the car wash.

According to an embodiment, when the processor determines that a vehicle enters the car wash, through the camera sensor, the processor may recognize the car wash brush through the camera sensor (S340). For example, the processor may increase an accuracy of determination regarding whether the vehicle enters the car wash by identifying whether both of the car wash platform and the car wash brush are recognized through the camera sensor. However, this is a simple example, and even though the processor satisfies any one of the recognitions of the car wash platform through the camera sensor or the recognition of the car wash brush through the camera sensor, it may be determined that the vehicle enters the car wash.

According to an embodiment, when both of the car wash platform and the car wash brush are recognized through the camera sensor, the processor may determine that it is necessary to execute the automatic vehicle wash mode. Accordingly, the processor may execute the automatic vehicle wash standby mode (S350).

According to an embodiment, in the automatic vehicle wash standby mode, the processor may determine whether it is identified that the distance between the car wash brush and the vehicle is within the threshold distance through the distance sensor (S360). The distance sensor may include a sensor that senses the distance between the vehicle and a surrounding object, and the threshold distance may include a distance at which the car wash brush approaches the vehicle to wash the vehicle. As a detailed example, the threshold distance may be set to a distance including 0, and when the distance between the vehicle and the car wash brush, which is sensed by the distance sensor, is 0, it may be identified that the car wash brush contacts the vehicle and it is necessary to execute the automatic vehicle wash mode.

According to an embodiment, when it is determined that the distance between the car wash brush and the vehicle is within the threshold distance, the processor may provide a notification for identifying whether the automatic vehicle wash mode is executed to the user (S370). For example, a notification that the automatic vehicle wash mode is executed may be provided to the user through a pop-up window on the display or an audio sound.

According to an embodiment, the processor may provide a notification for selecting whether to execute the automatic vehicle wash mode, and may also provide a notification for identifying whether to agree to automatically execute the automatic vehicle wash mode. This is a simple example, and the processor may provide a notification regarding whether the automatic vehicle wash mode is executed to the user through various types of messages.

According to an embodiment, the user may select whether to execute the automatic vehicle wash mode (S380). For example, the user may select a popup window displayed on the display or select whether to execute the automatic vehicle wash mode through a voice recognition.

According to an embodiment, when the user selects execution of the automatic vehicle wash mode, the processor may execute the automatic vehicle wash mode (S382). As another example, when the processor automatically executes the automatic vehicle wash mode and the user does not object to this, the processor may execute the automatic vehicle wash mode.

According to an embodiment, the processor may execute at least one of folding of an outside mirror of the vehicle, closing of a door glass, closing of a sunroof, switching-off of the rain sensor, locking of an automatic flush door handle, locking of a power tailgate, locking of a power sliding door, locking of an EV charging door, or locking of a frunk, or any combination thereof, when the automatic vehicle wash mode is executed.

According to an embodiment, when the processor does not recognize the car wash platform through the camera sensor, does not recognize the car wash brush through the camera sensor, or does not determine that the distance between the car wash brush and the vehicle is within the threshold distance, or the user does not select execution of the automatic vehicle wash mode, the processor may not execute the automatic vehicle wash mode (S384).

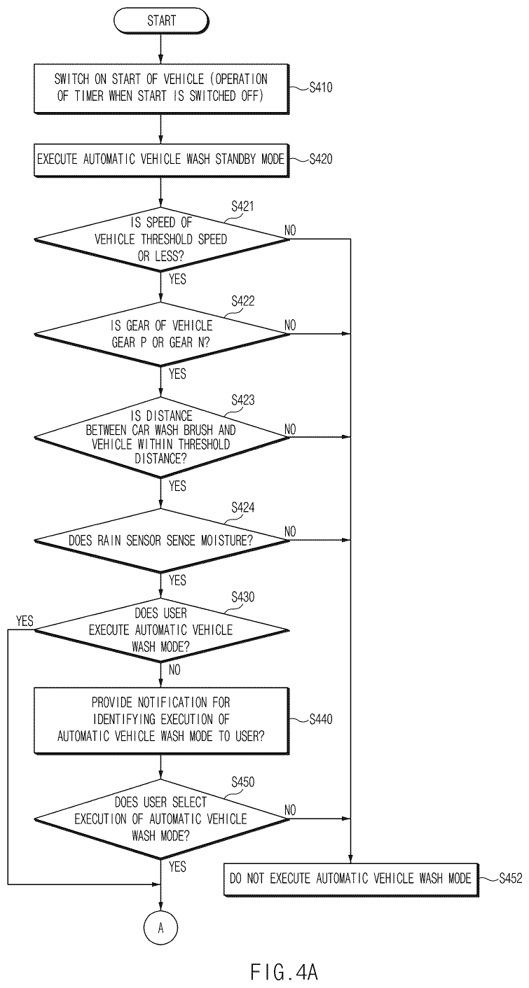

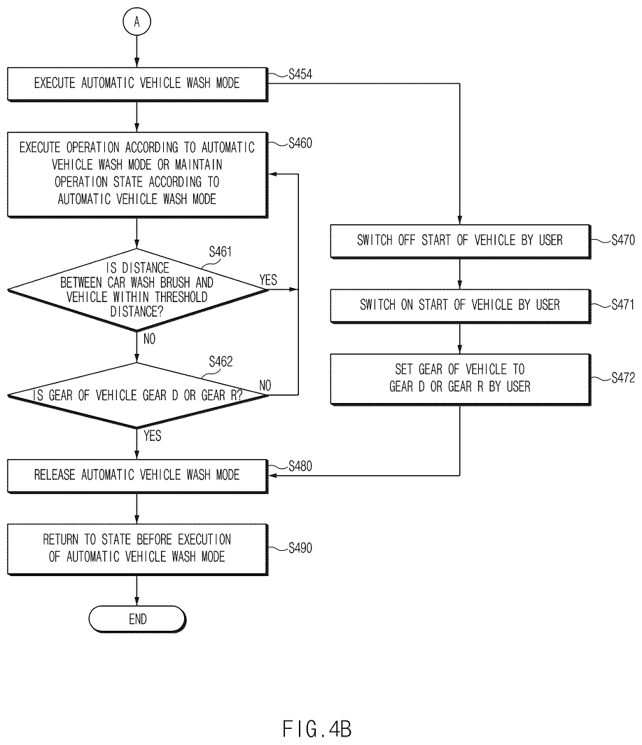

FIGS. 4A and 4B are flowcharts illustrating failsafe logic for the process of determining whether it is necessary to execute the automatic vehicle wash mode and a method for releasing the automatic vehicle wash mode in the vehicle control apparatus or method according to an embodiment of the present disclosure.

According to an embodiment, the processor may perform a process for executing the automatic vehicle wash standby mode or the automatic vehicle wash mode while the start of the vehicle ignition is switched on (S410). As another example, when the start of the vehicle is switched off, the processor may operate a timer for a preset time period to determine whether it is necessary to execute the automatic vehicle wash mode.

According to an embodiment, when it is determined that a vehicle enters the car wash through the camera sensor, the processor may execute the automatic vehicle wash standby mode (S420).

According to an embodiment, when the automatic vehicle wash standby mode is executed, the processor may determine whether it is necessary to execute the automatic vehicle wash mode. Then, the processor may determine whether it is necessary to execute the automatic vehicle wash mode according to a failsafe function.

According to an embodiment, the processor may determine whether it is necessary to execute the automatic vehicle wash mode, determining whether a speed of the vehicle is a threshold speed or less, whether a gear of the vehicle is set to gear “P” or gear “N”, whether it is identified that a distance between a car wash brush and the vehicle is within a threshold distance, through a distance sensor, or whether moisture is sensed through a rain sensor.

According to an embodiment, contents for determining whether it is necessary to execute the automatic vehicle wash mode as described above may be determined in parallel or sequentially.

For example, the processor may determine whether the speed of the vehicle is less than the threshold speed (S421). The threshold speed may include the speed at which the vehicle enters the car wash or the car wash machine to be washed. As a detailed example, the threshold speed may be set to 10 km/h.

For example, when it is determined that the speed of the vehicle is less than the threshold speed, the processor may determine whether the gear of the vehicle is set to gear “P” or gear “N” (S422). Then, the processor may determine that it is necessary to execute the automatic vehicle wash mode even when the gear of the vehicle is set not only to gear “P” or gear “N”, but also to a gear that may stop the vehicle.

For example, when it is determined that the vehicle's gear is set to gear “P” or gear “N”, the processor may determine whether the distance between the car wash brush and the vehicle is within the threshold distance through the distance sensor (S423). As a specific example, when the distance between the vehicle and the car wash brush sensed by the distance sensor is 0, it may be determined that the car wash brush contacts the vehicle.

For example, when it is determined that the car wash brush contacts the vehicle, the processor may determine whether moisture is sensed through the rain sensor (S424).

For example, when water droplets are sensed on the windshield or an outer plate of a vehicle through the rain sensor, the processor may determine that it is necessary to execute the automatic vehicle wash mode.

According to an embodiment, when it is necessary to execute the automatic vehicle wash mode, the processor may determine whether the user directly executed the automatic vehicle wash mode (S430).

When the user directly executed the automatic vehicle wash mode, there is no need to provide a notification for identifying whether the automatic vehicle wash mode is executed to the user, and thus, in this case, the processor may immediately execute the automatic vehicle wash mode. To the contrary, when the user does not directly execute the automatic vehicle wash mode, the processor may provide a notification for identifying whether the automatic vehicle wash mode is executed, to the user (S440). Then, the processor may provide a notification for identifying whether the automatic vehicle wash mode is executed, to the user, through a display or an audio.

According to an embodiment, when the user does not select execution of the automatic vehicle wash mode, the processor may not execute the automatic vehicle wash mode (S452).

According to an embodiment, when the user selects execution of the automatic vehicle wash mode or when the user does not object to the automatic vehicle wash mode being automatically executed, the processor may execute the automatic vehicle wash mode (S454).

According to an embodiment, when the automatic vehicle wash mode is executed, the processor may perform a control to execute an operation according to the automatic vehicle wash mode or maintain an operation state according to the automatic vehicle wash mode (S460).

For example, the processor may execute at least one of folding of the outside mirror of the vehicle, closing of the door glass, closing of the sunroof, switching-off of the rain sensor, locking of the automatic flush door handle, locking of the power tailgate, locking of the power sliding door, locking of the EV charging door, or locking of the frunk, or any combination thereof.

According to an embodiment, the processor may continuously determine whether the distance between the car wash brush and the vehicle is within the threshold distance through the distance sensor (S461).

For example, when the distance between the car wash brush and the vehicle through the distance sensor is maintained within the threshold distance, it may be determined that the car wash has not yet been completed as the car wash brush still contacts the vehicle, and thus, the operating state according to the automatic vehicle wash mode may be maintained.

For example, when the distance between the car wash brush and the vehicle through the distance sensor is more than the threshold distance, the processor may determine that the car wash brush does not contact the vehicle.

For example, when it is determined that the car wash brush does not contact the vehicle, the processor may determine whether the gear of the vehicle is set to gear “D” or gear “R” (S462). The processor may determine that the vehicle has been washed when the gear of the vehicle is set to gear “D” or gear “R”.

According to an embodiment, when it is determined that the vehicle has been washed, the processor may release the automatic vehicle wash mode (S480).

According to an embodiment, when the automatic vehicle wash mode is released, the processor may return the vehicle to the state before the automatic vehicle wash mode is executed (S490). The outside mirror of the vehicle, the door glass, the sunroof, the rain sensor, the automatic flush door handle, the power tailgate, the power sliding door, the EV charging door, the frunk, and the like may return to the state before the automatic vehicle wash mode was executed.

According to an embodiment, the user may need to release the automatic vehicle wash mode even after the automatic vehicle wash mode is executed. In this case, the user may release the automatic vehicle wash mode by starting the vehicle and operating the gear.

For example, when the user switches off the start of the vehicle (S470), switches on the start of the vehicle again (S471), and then sets the gear of vehicle to gear “D” or gear “R” (S472) while the automatic vehicle wash mode is executed, the processor may release the automatic vehicle wash mode (S480). However, this is a simple example, and the processor may be set to release the automatic vehicle wash mode simply by switching off the start of the vehicle and then switching it on again by the user.

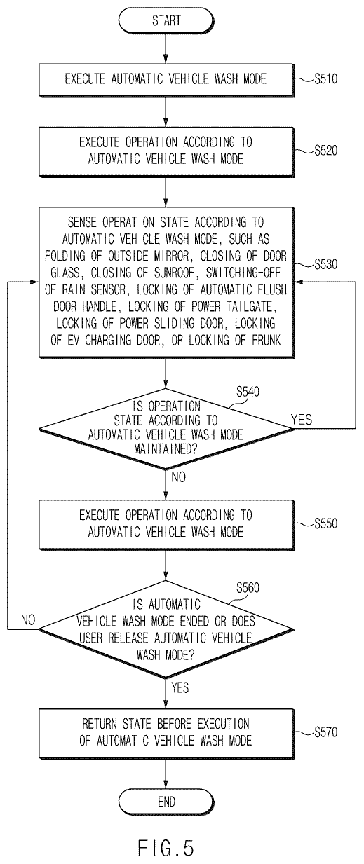

FIG. 5 is a flowchart illustrating a process for maintaining an operation state according to the automatic vehicle wash mode in the vehicle control apparatus or method according to an embodiment of the present disclosure.

According to an embodiment, when the automatic vehicle wash mode is executed (S510), the processor may execute an operation according to the automatic vehicle wash mode (S520).

According to an embodiment, the processor may sense an operation state according to the automatic vehicle wash mode (S530). For example, the processor may monitor a state, such as folding of the outside mirror of the vehicle, closing of the door glass, closing of the sunroof, switching-off of the rain sensor, locking of the automatic flush door handle, locking of the power tailgate, locking of the power sliding door, locking of the EV charging door, or locking of the frunk to identify whether they are maintained.

According to an embodiment, the processor may determine whether each operation state according to the automatic vehicle wash mode is maintained (S540).

According to embodiment, the processor may an continuously sense each operation state when the operation state according to the automatic vehicle wash mode is maintained.

According to an embodiment, when each operation state according to the automatic vehicle wash mode is not maintained, the processor may execute the automatic vehicle wash mode again (S550). When it is sensed that the door glass is opened due to a malfunction or a mistake of the user even though the automatic vehicle wash mode is executed and the door glass is closed, the processor may execute the automatic vehicle wash mode again to close the door glass.

According to an embodiment, the processor may determine whether the automatic vehicle wash mode has been terminated or whether the user has released the automatic vehicle wash mode (S560) as the vehicle has been washed.

According to an embodiment, when the automatic vehicle wash mode is ended or the user releases the automatic vehicle wash mode, the processor may return the vehicle to the state before the automatic vehicle wash mode is executed (S570).

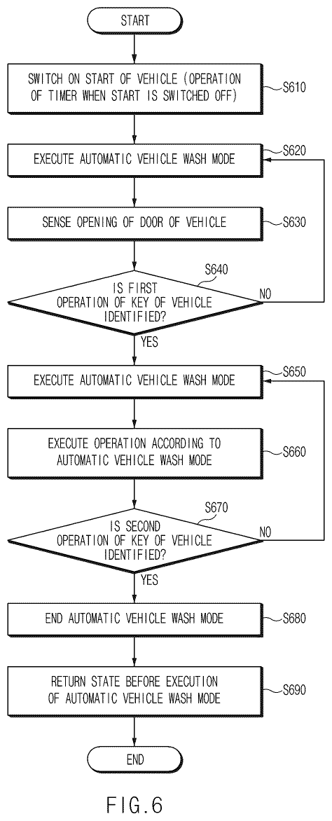

FIG. 6 is a flowchart illustrating a method of executing an automatic vehicle wash mode from an outside of a vehicle in the vehicle control apparatus or method according to an embodiment of the present disclosure.

According to an embodiment, the processor may perform a process for executing the automatic vehicle wash standby mode or the automatic vehicle wash mode while the start of the vehicle is switched on (S610). As another example, when the start of the vehicle is switched off state, the processor may operate a timer for a preset time period to determine whether it is necessary to execute the automatic vehicle wash mode.

According to an embodiment, the processor may execute the automatic vehicle wash standby mode as it is determined that it is necessary to execute the automatic vehicle wash mode (S620). According to an embodiment, when it is sensed that the vehicle door is opened in the automatic vehicle wash mode, the processor may determine that the driver has gotten out of the vehicle (S630).

According to an embodiment, the processor may determine whether the first operation of the key of the vehicle is recognized in a state in which it is determined that the driver has gotten out of the vehicle as it is sensed that the door of the vehicle is opened in the automatic vehicle wash mode (S640). In this example, the first operation may include an operation of pressing a specific button on the key of the vehicle with a specific rule.

As a detailed example, the driver may need to execute the automatic vehicle wash mode after getting out of the vehicle, and in this case, the automatic vehicle wash mode may be executed by using the key of the vehicle. Then, the driver may execute the automatic vehicle wash mode by pressing a specific button on the key of the vehicle regularly.

According to an embodiment, when the first operation of the key of the vehicle is recognized, the processor may execute the automatic vehicle wash mode (S650). Furthermore, the processor may execute operations according to the automatic vehicle wash mode (S660).

According to an embodiment, the user may end the automatic vehicle wash mode by using the key of the vehicle while the automatic vehicle wash mode is executed.

According to an embodiment, the processor may determine whether the second operation of the key of the vehicle is recognized while the automatic vehicle wash mode is executed through the first operation of the key of the vehicle (S670). In this example, the second operation may be the same operation as the first operation or may be a different operation. As a detailed example, when the first operation is an operation of pressing a lock button of the key of the vehicle for 5 seconds, the second operation may be set to an operation of pressing an unlock button of the key of the vehicle for 5 seconds. However, this is a simple example, and thus, the first operation and the second operation may be set separately in various ways.

According to an embodiment, when the second operation of the key of the vehicle is recognized in the automatic vehicle wash mode, the processor may end the automatic vehicle wash mode (S680).

According to an embodiment, when the automatic vehicle wash mode is ended, the processor may return the vehicle to the state before the automatic vehicle wash mode is executed (S690).

According to an embodiment according to FIG. 6, even though the user gets out of the vehicle without executing the automatic vehicle wash mode, the automatic vehicle wash mode may be executed from an outside the vehicle by using the key of the vehicle.

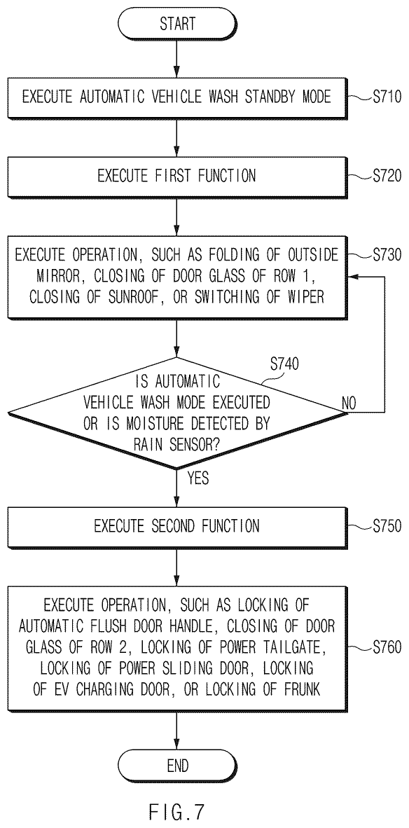

FIG. 7 is a flowchart illustrating a process, in which operations according to execution of automatic vehicle wash standby mode and operations according to execution of the automatic vehicle wash mode are operated separately in the vehicle control apparatus or the vehicle control method according to an embodiment of the present disclosure.

According to an embodiment, the processor may operate an operation according to the automatic vehicle wash standby mode and an operation according to the automatic vehicle wash mode separately.

According to an embodiment, when the processor determines that the vehicle enters the car wash through the camera sensor, the processor may execute the automatic vehicle wash standby mode (S710).

According to an embodiment, when the automatic vehicle wash standby mode is executed, the processor may execute the first function (S720).

For example, when the first function is executed, the processor may perform at least one of folding of the outside mirror of the vehicle, closing of a door glass of row 1, closing of the sunroof, or switching-off of the wiper, or any combination thereof.

According to an embodiment, the processor may execute the second function when the automatic vehicle wash mode is executed while the automatic vehicle wash standby mode is executed, or when the rain sensor senses moisture (S740).

For example, the processor may execute the automatic vehicle wash mode when a speed of the vehicle is a threshold speed or less, when a gear of the vehicle is set to gear “P” or gear “N”, when it is identified that a distance between a car wash brush and the vehicle is within a threshold distance, through a distance sensor, when moisture is sensed through a rain sensor, or when shaking of the vehicle is sensed through a sensor configured to sense the shaking of the vehicle, in the automatic vehicle wash standby mode.

As another example, when moisture is sensed through the rain sensor in the automatic vehicle wash standby mode, the processor may determine that washing of the vehicle has started and immediately execute the second function.

According to an embodiment, when the second function is executed, the processor may perform at least one of folding of the outside mirror of the vehicle, closing of the door glass, closing of the sunroof, switching-off of the rain sensor, locking of the automatic flush door handle, locking of the power tailgate, locking of the power sliding door, locking of the EV charging door, or locking of the frunk, or any combination thereof.

Then, operations included in the first function and the second function may vary depending on a system or a setting of the user. Furthermore, operations that are not included in the first function may be included in consideration of the first function according to the automatic vehicle wash standby mode.

According to an embodiment according to FIG. 7, the processor first executes functions that need to be operated first even before the automatic vehicle wash mode is executed, depending on a direction or a speed, at which the vehicle wash progresses, and thus, it may control the vehicle such that damage to the vehicle or the user may be prevented.

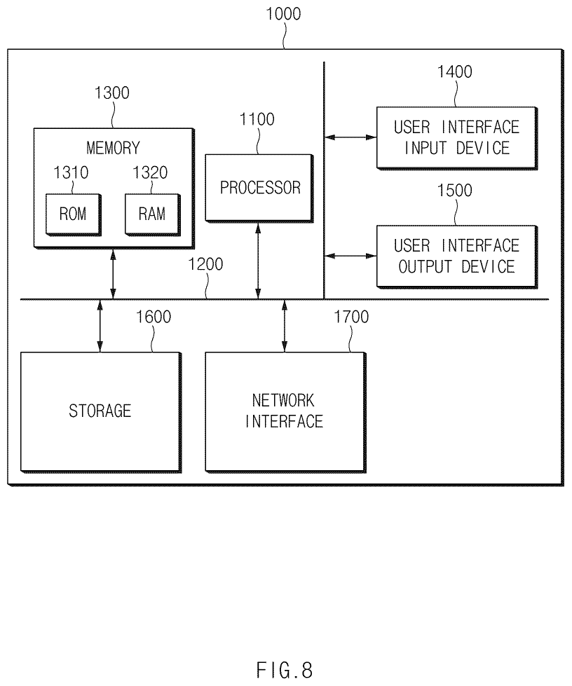

FIG. 8 illustrates a computing system associated with a vehicle control apparatus or method according to an embodiment of the present disclosure.

Referring to FIG. 8, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (i.e., the memory 1300 and/or the storage 1600) such as a RAM memory, a flash memory, a ROM memory, an EPROM memory, an EEPROM memory, a register, a hard disk, a removable disk, a CD-ROM.

The storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The present technology may allow the user to conveniently execute an automatic vehicle wash mode by automatically recognizing a car wash and notifying a user whether the automatic vehicle wash mode is executed.

Furthermore, the present technology may improve an accuracy of determination of whether a vehicle enters a car wash by using a transmission, a distance sensor, a rain sensor, and a shaking sensing sensor of a vehicle.

Furthermore, the present technology may prevent damage to a user or a vehicle by performing functions that are preferentially required before car washing begins in an automatic vehicle wash standby mode even when a user does not execute an automatic vehicle wash mode after the vehicle enters the car wash.

Furthermore, the present technology may prevent operations according to an automatic vehicle wash mode from being changed while a vehicle is washed by continuously sensing whether an operation state according to execution of the automatic vehicle wash mode is maintained.

In addition, various effects directly or indirectly recognized through the present document may be provided.

The above description is a simple illustrative description of the technical spirit of the present disclosure, and the present disclosure may be variously modified and altered by a person having ordinary skill in the art, to which the present disclosure pertains, without departing from the essential characteristics of the present disclosure.

Therefore, the embodiments of the present disclosure are provided to explain the spirit and scope of the present disclosure, but not to limit them, so that the spirit and scope of the present disclosure is not limited by the embodiments. The scope of the present disclosure should be construed based on the accompanying claims, and all the technical ideas within the scope equivalent to the claims should be included in the scope of the present disclosure.

What is claimed is:

1. A vehicle control apparatus comprising:
a memory configured to store program instructions; and
a processor configured to execute the program instructions,
wherein the processor is configured to:
execute an automatic vehicle wash standby mode of determining whether it is necessary to execute an automatic vehicle wash mode of operating a function required for a vehicle before the vehicle is washed, based on an identification that the vehicle enters a car wash, through a camera sensor;
determine that it is necessary to execute the automatic vehicle wash mode, based on at least one of that a speed of the vehicle is a threshold speed or less, that a gear of the vehicle is set to gear “P” or gear “N”, that it is identified that a distance between a car wash brush and the vehicle is within a threshold distance, through a distance sensor, that moisture is sensed through a rain sensor, or that shaking of the vehicle is sensed through a sensor configured to sense the shaking of the vehicle, or any combination thereof, in the automatic vehicle wash standby mode; and
execute the automatic vehicle wash mode.

2. The vehicle control apparatus of claim 1, wherein the processor is further configured to:
execute at least one of folding of an outside mirror of the vehicle, closing of a door glass, closing of a sunroof, switching-off of the rain sensor, locking of an automatic flush door handle, locking of a power tailgate, locking of a power sliding door, locking of an EV charging door, or locking of a frunk, or any combination thereof, based on that the automatic vehicle wash mode is executed.

3. The vehicle control apparatus of claim 1, wherein the processor is further configured to:
provide a notification for identifying whether the automatic vehicle wash mode is executed, through at least one of a display or an audio component, or any combination thereof, based on that it is determined that it is necessary to execute the automatic vehicle wash mode, in the automatic vehicle wash standby mode.

4. The vehicle control apparatus of claim 3, wherein the processor is further configured to:
not execute the automatic vehicle wash mode, based on an identification that the automatic vehicle wash mode is not executed by a user; or
execute the automatic vehicle wash mode, based on an identification that the automatic vehicle wash mode is executed by the user.

5. The vehicle control apparatus of claim 1, wherein the processor is further configured to:
release the automatic vehicle wash mode based on an identification that a start of the vehicle is switched on again after the start of the vehicle is switched off, in the automatic vehicle wash mode; or
release the automatic vehicle wash mode based on an identification that the gear of the vehicle is set to gear “D” or gear “R”, in the automatic vehicle wash mode.

6. The vehicle control apparatus of claim 5, wherein the processor is further configured to:
based on that the automatic vehicle wash mode is released,
return at least one of an outside mirror, a door glass, a sunroof, the rain sensor, an automatic flush door handle, a power tailgate, a power sliding door, an EV charging door, or a frunk of the vehicle, or any combination thereof to a state before the automatic vehicle wash mode is executed.

7. The vehicle control apparatus of claim 2, wherein the processor is further configured to:
execute the automatic vehicle wash mode again, based on an identification that a state corresponding to at least one of folding of the outside mirror of the vehicle, closing of the door glass, closing of the sunroof, switching-off of the rain sensor, locking of the automatic flush door handle, locking of the power tailgate, locking of the power sliding door, locking of the EV charging door, or locking of the frunk, or any combination thereof is not maintained.

8. The vehicle control apparatus of claim 1, wherein the processor is further configured to:
based on that the automatic vehicle wash standby mode is executed,
execute a first function including at least one of folding of an outside mirror of the vehicle, closing of a door glass of row 1, closing of a sunroof, or switching-off of a wiper, or any combination thereof; and
based on that the automatic vehicle wash mode is executed,
execute a second function including at least one of locking of an automatic flush door handle, closing of a door glass of row 2 or more, locking of a power tailgate, locking of a power sliding door, locking of an EV charging door, or a locking of a frunk, or any combination thereof.

9. The vehicle control apparatus of claim 1, wherein the processor is further configured to:
based on an identification that a start of the vehicle is switched off, in the automatic vehicle wash standby mode,
determine that it is necessary to execute the automatic vehicle wash mode, based on at least one of that the speed of the vehicle is the threshold speed or less, that the gear of the vehicle is set to gear “P” or gear “N”, that the distance between the car wash brush and the vehicle is identified to be within the threshold distance through the distance sensor, that moisture is sensed through the rain sensor, or that shaking of the vehicle is sensed through the sensor configured to sense the shaking of the vehicle, or any combination thereof, by operating a timer for a preset time period.

10. A vehicle control apparatus comprising:
a memory configured to store program instructions; and
a processor configured to execute the program instructions,
wherein the processor is configured to:
execute an automatic vehicle wash standby mode of determining whether it is necessary to execute an automatic vehicle wash mode of operating a function required for a vehicle before the vehicle is started to be washed, based on an identification that the vehicle enters a car wash, through a camera sensor; and
execute the automatic vehicle wash mode, based on that opening of a door of the vehicle is identified and a first operation of a key of the vehicle is identified, in the automatic vehicle wash standby mode.

11. The vehicle control apparatus of claim 10, wherein the processor is further configured to:
release the automatic vehicle wash mode, based on that a second operation of the key of the vehicle is identified, in the automatic vehicle wash mode.

12. A vehicle control method comprising:
executing, by a processor, an automatic vehicle wash standby mode of determining whether it is necessary to execute an automatic vehicle wash mode of operating a function required for a vehicle before the vehicle is washed, based on an identification that the vehicle enters a car wash, through a camera sensor;
determining, by the processor, that it is necessary to execute the automatic vehicle wash mode, based on that a speed of the vehicle is a threshold speed or less, that a gear of the vehicle is set to gear “R” or gear “N”, that it is identified that a distance between a car wash brush and the vehicle is within a threshold distance, through a distance sensor, that moisture is sensed through a rain sensor, or that shaking of the vehicle is sensed through a sensor configured to sense the shaking of the vehicle, or at least one of any combinations thereof, in the automatic vehicle wash standby mode; and
executing, by the processor, the automatic vehicle wash mode.

13. The vehicle control method of claim 12, wherein the executing, by the processor, of the automatic vehicle wash mode includes:
executing, by the processor, at least one of folding of an outside mirror of the vehicle, closing of a door glass, closing of a sunroof, switching-off of the rain sensor, locking of an automatic flush door handle, locking of a power tailgate, locking of a power sliding door, locking of an EV charging door, or locking of a frunk, or any combination thereof, based on that the automatic vehicle wash mode is executed.

14. The vehicle control method of claim 12, further comprising:
providing, by the processor, a notification for identifying whether the automatic vehicle wash mode is executed, through at least one of a display or an audio component, or any combination thereof, based on a determination that it is necessary to execute the automatic vehicle wash mode, in the automatic vehicle wash standby mode.

15. The vehicle control method of claim 14, wherein the executing, by the processor, of the automatic vehicle wash mode includes:
not executing, by the processor, the automatic vehicle wash mode, when it is identified that the automatic vehicle wash mode is not executed by a user, or executing the automatic vehicle wash mode, when it is identified that the automatic vehicle wash mode is executed by the user.

16. The vehicle control method of claim 12, further comprising:
releasing, by the processor, the automatic vehicle wash mode based on an identification that a start of the vehicle is switched on again after the start of the vehicle is switched off, in the automatic vehicle wash mode, or releasing the automatic vehicle wash mode based on an identification that the gear of the vehicle is set to gear “D” or gear “R”, in the automatic vehicle wash mode.

17. The vehicle control method of claim 16, wherein the releasing, by the processor, of the automatic vehicle wash mode based on the identification that the start of the vehicle is switched on again after the start of the vehicle is switched off, in the automatic vehicle wash mode, or the releasing of the automatic vehicle wash mode based on the identification that the gear of the vehicle is set to gear “D” or gear “R”, in the automatic vehicle wash mode includes:
returning, by the processor, at least one of an outside mirror, a door glass, a sunroof, the rain sensor, an automatic flush door handle, a power tailgate, a power sliding door, an EV charging door, or a frunk of the vehicle, or any combination thereof to a state before the automatic vehicle wash mode is executed, based on that the automatic vehicle wash mode is released.

18. The vehicle control method of claim 13, wherein the executing, by the processor, of the automatic vehicle wash mode includes:
executing the automatic vehicle wash mode again, based on an identification that a state corresponding to at least one of folding of the outside mirror of the vehicle, closing of the door glass, closing of the sunroof, switching-off of the rain sensor, locking of the automatic flush door handle, locking of the power tailgate, locking of the power sliding door, locking of the EV charging door, or locking of the frunk, or any combination thereof is not maintained.

19. The vehicle control method of claim 12, wherein the executing, by the processor, of the automatic vehicle wash standby mode of determining whether it is necessary to execute the automatic vehicle wash mode of operating the function required for the vehicle before the vehicle is washed, based on the identification that the vehicle enters the car wash, through the camera sensor includes:
executing, by the processor, a first function including at least one of folding of an outside mirror of the vehicle, closing of a door glass of row 1, closing of a sunroof, or switching-off of a wiper, or any combination thereof, based on the automatic vehicle wash standby mode being executed, and
wherein the executing, by the processor, of the automatic vehicle wash mode includes:
executing, by the processor, a second function including at least one of locking of an automatic flush door handle, closing of a door glass of row 2 or more, locking of a power tailgate, locking of a power sliding door, locking of an EV charging door, or a locking of a frunk, or any combination thereof, based on the automatic vehicle wash mode being executed.

20. The vehicle control method of claim 12, wherein the determining, by the processor, that it is necessary to execute the automatic vehicle wash mode, based on that the speed of the vehicle is the threshold speed or less, that the gear of the vehicle is set to gear “R” or gear “N”, that it is identified that the distance between the car wash brush and the vehicle is within the threshold distance, through the distance sensor, that moisture is sensed through the rain sensor, or that shaking of the vehicle is sensed through the sensor configured to sense the shaking of the vehicle, or at least one of any combinations thereof, in the automatic vehicle wash standby mode includes:
determining, by a controller, that it is necessary to execute the automatic vehicle wash mode, based on at least one of that the speed of the vehicle is the threshold speed or less, that the gear of the vehicle is set to gear “P” or gear “N”, that the distance between the car wash brush and the vehicle is identified to be within the threshold distance through the distance sensor, that moisture is sensed through the rain sensor, or that shaking of the vehicle is sensed through the sensor configured to sense the shaking of the vehicle, or any combination thereof, by operating a timer for a preset time period, based on an identification that a start of the vehicle is switched off, in the automatic vehicle wash standby mode.
